(19) United States
(12) Patent Application Publication
(10) Pub. No.: US 2017/0161427 A1
(43) Pub. Date: Jun. 8, 2017

(54) COLLECTION AMOUNT REGULATION ASSIST APPARATUS, COLLECTION AMOUNT REGULATION ASSIST METHOD, AND COMPUTER-READABLE RECORDING MEDIUM

(71) Applicant: NEC Solution Innovators, Ltd., Koto-ku, Tokyo (JP)

(72) Inventor: Jun NODA, Tokyo (JP)

(73) Assignee: NEC Solution Innovators, Ltd., Koto-ku, Tokyo (JP)

(21) Appl. No.: 15/324,315

(22) PCT Filed: Jun. 4, 2015
(86) PCT No.: PCT/JP2015/066238

§ 371 Date: Jan. 6, 2017

(30) Foreign Application Priority Data
Jul. 8, 2014 (JP) 2014-140870

(51) Int. Cl. G06F 17/00; G06Q 50/02

(52) U.S. Cl. CPC G06F 17/60; G06Q 50/02

(57) ABSTRACT

To assist in regulation of an amount of agricultural produce collected at a collection/loading station, a collection amount regulation assist apparatus 10 includes a trend line setting unit 11 for setting, using a scheduled amount of the agricultural produce to be collected per day, a trend line indicating an ideal change in an amount of the agricultural produce to be collected from when collection of the agricultural produce is started until the collection ends, and an estimation unit 12 for obtaining a deviation ratio indicating a degree of deviation in an amount of the agricultural produce that has been collected from the trend line at a specific time point, and estimating whether or not the agricultural produce will be insufficient based on the obtained deviation ratio.

### TECHNICAL FIELD

The present invention relates to a collection amount regulation assist apparatus and a collection amount regulation method for assisting in regulation of the amount of agricultural produce collected at a collection/loading station, and further relates to a computer-readable recording medium storing a program for realizing them.

### BACKGROUND ART

In recent years, particularly for shipment of leafy vegetables, to ensure the contractual amount to be shipped to customers such as retailers, a shipping coordination producers group is formed by producers, and this group is managed such that the amounts of agricultural produce to be delivered by producers belonging to the group (hereinafter referred to as an “amount to be delivered”) complement one another. In such management, a person in charge of a collection/loading station or a local instructor (hereinafter, these people will be referred to collectively as an “administrator”) gives each producer instructions to harvest and ship agricultural produce such that the amount of agricultural produce collected from each producer at the collection/loading station reaches the contractual amount to be shipped.

Specifically, during a period from the time when collection of agricultural produce is started until the time when the collection ends, the administrator determines whether or not a final amount to be collected will reach the contractual amount to be shipped, based on the amount of the agricultural produce that has already been collected at the collection/loading station, a shortfall relative to the contractual amount to be shipped, and the like. If the result of the determination is that the final amount to be collected will not reach the contractual amount to be shipped, the administrator makes, to each producer, a request to bring additional agricultural produce to the collection/loading station.

If the final amount to be collected falls short of the contractual amount to be shipped, there is a concern that the shipping contract is canceled, and for producers, there is a concern of a risk to their revenue. Furthermore, commonly, leafy vegetables significantly degrade as time passes. For this reason, leafy vegetables that cannot be shipped on the day they are brought excluding those that can be stored in a cold storage are disposed. That is to say, if the amount brought to the collection/loading station greatly surpasses the contractual amount to be shipped and the cold storage cannot hold all of the excess, the producers will suffer a loss.

Accordingly, the administrator bears a heavy responsibility to regulate the amount of agricultural produce to be collected, which is a great burden on the administrator. Therefore, conventionally, various kinds of systems have been proposed in order to facilitate the regulation of the amount of leafy vegetables or the like to be sold and the amount to be collected (shipped) (e.g. see Patent Documents 1 and 2).

For example, in a system disclosed in Patent Document 1, if a certain difference has occurred between the number of products that have been actually collected from a producer and the number of products that are scheduled to be ordered, a warning is issued to an administrator. Therefore, even if, in particular, the yield or the amount ordered suddenly fluctuates, the loss that a producer and a retailer suffer can be minimized.

In a system disclosed in Patent Document 2, the number of products to be sold on a day is predicted from past product sales data and a sales situation of the product on the day. If the number of delivered products is smaller than the predicted number to be sold, a unit price for delivery is determined so as to provide an incentive to a producer. As a result, a shortage in a product is avoided. Therefore, primarily the loss that a retailer suffers is minimized.

### LIST OF PRIOR ART DOCUMENTS

### Patent Document

Patent Document 1: JP 2004-001909A

Patent Document 2: JP 2013-140481A

### DISCLOSURE OF THE INVENTION

### Problems to be Solved by the Invention

Incidentally, in a case where management is run such that producers mutually complement the amount to be delivered, since agricultural produce is individually brought to a collection/loading station by respective producers, the amount of agricultural produce brought to the collection/loading station varies depending on the time period. However, in the systems disclosed in the aforementioned Patent Documents 1 and 2, merely a difference between a current amount collected and a scheduled amount to be collected is calculated, and consideration is not at all given to variation depending on the time period. For this reason, it is difficult to predict a final amount to be collected. As a result, it is also difficult to solve the aforementioned problems due to a shortage in the amount collected and an excessive amount collected.

An exemplary object of the present invention is to solve the foregoing problems, and provide a collection amount regulation assist apparatus, a collection amount regulation assist method, and a computer-readable recording medium that enable prediction of an amount of agricultural produce to be collected even in a case where the agricultural produce is brought to a collection/loading station by a plurality of producers.

### Means for Solving the Problems

To achieve the above-stated object, a first collection amount regulation assist apparatus in one aspect of the present invention is an apparatus for assisting in regulation of an amount of agricultural produce collected at a collection/loading station, including:

a trend line setting unit for setting a trend line indicating an ideal change in an amount of the agricultural produce to be collected from when collection of the agricultural produce is started until the collection ends, using a scheduled amount of the agricultural produce to be collected per day; and

an estimation unit for obtaining a deviation ratio indicating a degree of deviation in an amount of the agricultural produce that has been collected from the trend line at a specific time point, and estimating, based on the obtained deviation ratio, whether or not the agricultural produce will be insufficient.

Also, to achieve the above-stated object, a second collection amount regulation assist apparatus in one aspect of the present invention is an apparatus for assisting in regulation of an amount of agricultural produce collected at a collection/loading station, including:

a learning estimation unit for constructing a learning model of a deviation ratio by using learning data, applying the deviation ratio at a specific time point to the constructed learning model, and estimating whether or not the agricultural produce will be insufficient based on a thus obtained result,

wherein the learning data includes:

the deviation ratio calculated using a trend line that is set using a scheduled amount of the agricultural produce to be collected per day and indicates an ideal change in an amount of the agricultural produce to be collected from when collection of the agricultural produce is started until the collection ends, the deviation ratio indicating a degree of deviation in an amount of the agricultural produce that has been collected from the trend line at a plurality of time points on previous days; and

a regulation result indicating whether the amount of the collected agricultural produce on a corresponding day was successfully or unsuccessfully regulated.

To achieve the above-stated object, a first collection amount regulation assist method in one aspect of the present invention is a method for assisting in regulation of an amount of agricultural produce collected at a collection/loading station, including:

a step (a) of setting a trend line indicating an ideal change in an amount of the agricultural produce to be collected from when collection of the agricultural produce is started until the collection ends, using a scheduled amount of the agricultural produce to be collected per day; and

a step (b) of obtaining a deviation ratio indicating a degree of deviation in an amount of the agricultural produce that has been collected from the trend line at a specific time point, and estimating, based on the obtained deviation ratio, whether or not the agricultural produce will be insufficient.

Also, to achieve the above-stated object, a second collection amount regulation assist method in one aspect of the present invention is a method for assisting in regulation of an amount of agricultural produce collected at a collection/loading station, including:

a step of constructing a learning model of a deviation ratio by using learning data, applying the deviation ratio at a specific time point to the constructed learning model, and estimating whether or not the agricultural produce will be insufficient based on a thus obtained result,

wherein the learning data includes:

the deviation ratio calculated using a trend line that is set using a scheduled amount of the agricultural produce to be collected per day and indicates an ideal change in an amount of the agricultural produce to be collected from when collection of the agricultural produce is started until the collection ends, the deviation ratio indicating a degree of deviation in an amount of the agricultural produce that has been collected from the trend line at a plurality of time points on previous days; and

a regulation result indicating whether the amount of the collected agricultural produce on a corresponding day was successfully or unsuccessfully regulated.

To achieve the above-stated object, a first computer-readable recording medium in one aspect of the present invention is a computer-readable recording medium storing a program for assisting, using a computer, in regulation of an amount of agricultural produce collected at a collection/loading station, the program including a command for causing the computer to execute:

a step (a) of setting a trend line indicating an ideal change in an amount of the agricultural produce to be collected from when collection of the agricultural produce is started until the collection ends, using a scheduled amount of the agricultural produce to be collected per day; and

a step (b) of obtaining a deviation ratio indicating a degree of deviation in an amount of the agricultural produce that has been collected from the trend line at a specific time point, and estimating, based on the obtained deviation ratio, whether or not the agricultural produce will be insufficient.

Furthermore, to achieve the above-stated object, a second computer-readable recording medium in one aspect of the present invention is a computer-readable recording medium storing a program for assisting, using a computer, in regulation of an amount of agricultural produce collected at a collection/loading station, the program including a command for causing the computer to execute:

a step of constructing a learning model of a deviation ratio by using learning data, applying the deviation ratio at a specific time point to the constructed learning model, and estimating whether or not the agricultural produce will be insufficient based on a thus obtained result,

wherein the learning data includes:

the deviation ratio calculated using a trend line that is set using a scheduled amount of the agricultural produce to be collected per day and indicates an ideal change in an amount of the agricultural produce to be collected from when collection of the agricultural produce is started until the collection ends, the deviation ratio indicating a degree of deviation in an amount of the agricultural produce that has been collected from the trend line at a plurality of time points on previous days; and

a regulation result indicating whether the amount of the collected agricultural produce on a corresponding day was successfully or unsuccessfully regulated.

### Advantageous Effects of the Invention

As described above, according to the present invention, an amount of agricultural produce to be collected can be predicted even in a case where the agricultural produce is brought to a collection/loading station by a plurality of producers.

### BRIEF DESCRIPTION OF THE DRAWINGS

FIG. 1 is a block diagram showing a schematic configuration of a collection amount regulation assist apparatus according to Embodiment 1 of the present invention.

FIG. 2 is a block diagram showing a specific configuration of the collection amount regulation assist apparatus according to Embodiment 1 of the present invention.

FIG. 3 is a diagram showing an example of a trend line that is set in Embodiment 1 of the present invention.

FIG. 4 is a flowchart showing operations of the collection amount regulation assist apparatus according to Embodiment 1 of the present invention.

FIG. 5 is a block diagram showing a specific configuration of a collection amount regulation assist apparatus according to Embodiment 2 of the present invention.

FIG. 6 is an illustrative diagram for illustrating a concept of learning data used in Embodiment 2 of the present invention.

FIG. 7 is a diagram showing a specific example of the learning data used in Embodiment 2 of the present invention.

FIG. 8 is an illustrative diagram for illustrating a learning model used in Embodiment 2 of the present invention.

FIG. 9 is a flowchart showing operations of the collection amount regulation assist apparatus according to Embodiment 2 of the present invention.

FIG. 10 is a block diagram showing a specific configuration of a collection amount regulation assist apparatus according to Embodiment 3 of the present invention.

FIG. 11 is a block diagram showing an example of a computer that realizes the collection amount regulation assist apparatuses according to Embodiments 1 to 3 of the present invention.

### MODE FOR CARRYING OUT THE INVENTION

### Embodiment 1

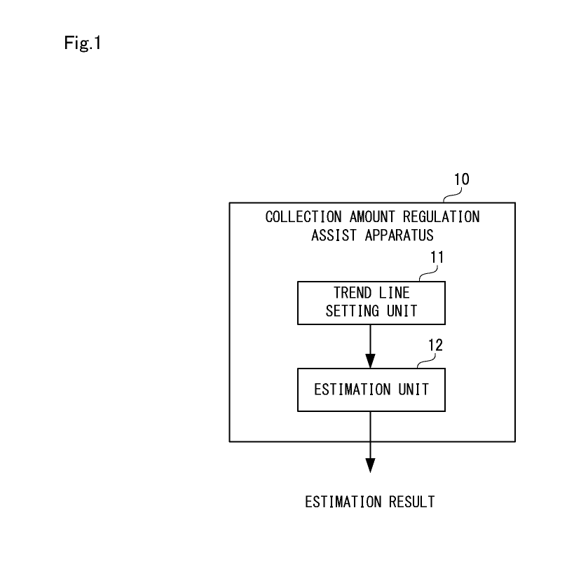

Hereinafter, a collection amount regulation assist apparatus, a collection amount regulation assist method, and a program according to Embodiment 1 of the present invention will be described with reference to FIGS. 1 to 4.

### Configuration of Apparatus

First, a configuration of the collection amount regulation assist apparatus according to Embodiment 1 of the present invention will be described using FIG. 1. FIG. 1 is a block diagram showing a schematic configuration of the collection amount regulation assist apparatus according to Embodiment 1 of the present invention.

A collection amount regulation assist apparatus 10 according to Embodiment 1 shown in FIG. 1 is an apparatus for assisting in regulation of the amount of agricultural produce collected at a collection/loading station. At the collection/loading station, agricultural produce is collected such that the amount of agricultural produce to be collected will reach a scheduled amount to be collected per day (hereinafter referred to as a “daily scheduled amount to be collected”). The daily scheduled amount to be collected is set based on the amount to be shipped that has been agreed upon with shipping destinations (contractual amount to be shipped).

As shown in FIG. 1, the collection amount regulation assist apparatus 10 is provided with a trend line setting unit 11 and an estimation unit 12. Of these units, the trend line setting unit 11 sets a trend line using a scheduled amount of agricultural produce to be collected per day. The trend line is a line that indicates an ideal change in the amount of agricultural produce to be collected from when collection of the agricultural produce is started until the collection ends.

The estimation unit 12 obtains a deviation ratio, which indicates a degree of deviation in the amount of collected agricultural produce from the trend line at a specific time point, and estimates whether or not the agricultural produce will be insufficient based on the obtained deviation ratio.

Thus, the collection amount regulation assist apparatus 10 sets the trend line while giving consideration to fluctuation in the amount to be collected, and determines, based thereon, whether or not the amount collected is insufficient. Therefore, with the collection amount regulation assist apparatus 10, the amount of agricultural produce to be collected can be predicted even in a case where the agricultural produce is brought to a collection/loading station by a plurality of producers.

In Embodiment 1, the agricultural produce that is subjected to collection amount regulation is not particularly limited. However, the collection amount restriction is particularly effective for agricultural produce that is required to be fresh, e.g. leafy vegetables, vegetables grown outdoors, fruits, fresh flowers, and the like.

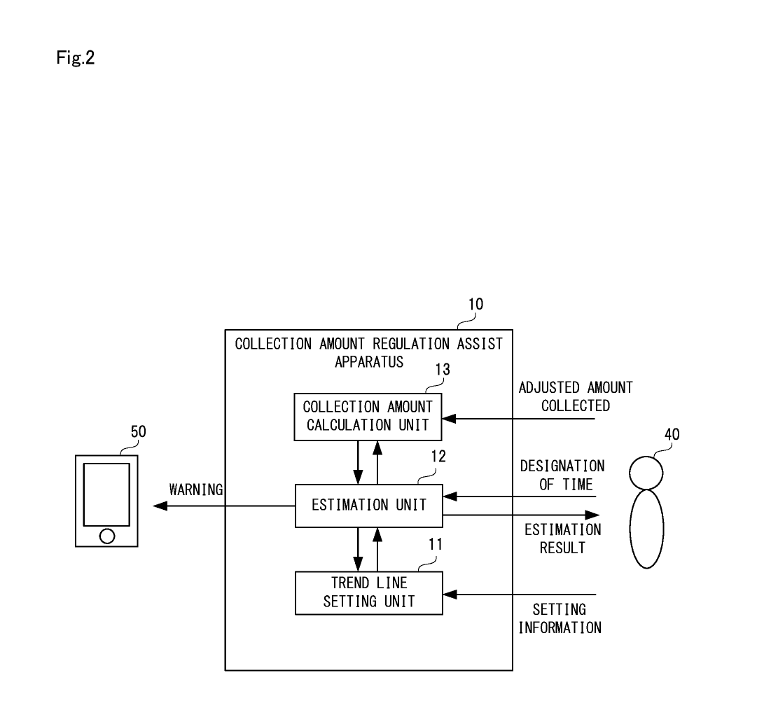

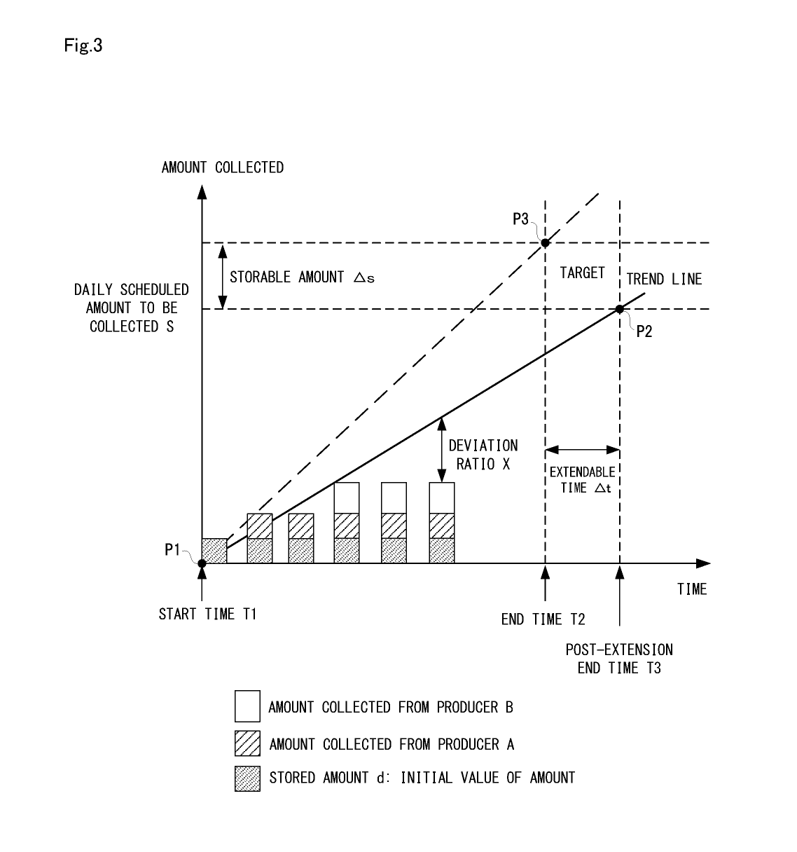

Subsequently, the configuration of the collection amount regulation assist apparatus 10 according to Embodiment 1 will be more specifically described using FIGS. 2 and 3. FIG. 2 is a block diagram showing a specific configuration of the collection amount regulation assist apparatus according to Embodiment 1 of the present invention. FIG. 3 is a diagram showing an example of the trend line that is set in Embodiment 1 of the present invention.

First, in Embodiment 1, the collection amount regulation assist apparatus 10 is provided with a collection amount calculation unit 13 as well as the trend line setting unit 11 and the estimation unit 12, as shown in FIG. 2. Upon a producer delivering agricultural produce to a collection/loading station, an administrator 40 obtains an adjusted amount collected from each producer, and inputs the obtained adjusted amount collected to the collection amount regulation assist apparatus 10. Note that the adjusted amount collected is input by the administrator 40 via an input device or a terminal device (not shown in FIG. 2).

Here, the “adjusted amount collected” means an amount obtained by subtracting an amount of agricultural produce that does not satisfy certain standards provided in advance for shipping, from an amount of agricultural produce that has actually been delivered to the collection/loading station by each producer. This is because the agricultural produce delivered by producers may include agricultural produce that does not satisfy certain standards (nonstandard agricultural produce).

Upon the adjusted amount collected from each producer being input by the administrator 40, the collection amount calculation unit 13 adds up adjusted amounts collected from each producer that were calculated from when collection was started up to the present, and calculates the latest amount collected. The collection amount calculation unit 13 then outputs the calculated amount collected to the estimation unit 12. The calculated latest amount collected corresponds to an amount of agricultural produce that is ready to be shipped at the collection/loading station, i.e. an amount that is ready to be shipped.

In Embodiment 1, the trend line setting unit 11 sets, as the trend line, a linear function in a coordinate system using the amount collected and the time as two orthogonal axes, as shown in FIG. 3. Specifically, in the example in FIG. 3, start time T1 when collection of agricultural produce is started, end time T2 when the collection of agricultural produce ends, and a daily scheduled amount to be collected S are set. Also, ΔS is set as an amount that can be stored in a cold storage at the collection/loading station (storable amount).

Furthermore, collection of agricultural produce at the collection/loading station ends, in principle, at the end time T2. However, in practice, even after the end time T2, agricultural produce is accepted for a while, and thus the end time T2 has been extended. For this reason, in the example in FIG. 2, an extendable time period is denoted as At, and the post-extension end time is denoted as T3.

Accordingly, at the collection/loading station, if the final amount to be collected is greater than or equal to the daily scheduled amount to be collected S and is less than or equal to the sum of the daily scheduled amount S and the storable amount ΔS (daily scheduled amount S+storable amount ΔS) during a period from the end time T2 until the post-extension end time T3, a problem due to a shortage in the amount collected and a problem due to an excessive amount collected described in the Background Art do not occur.

Therefore, in the example in FIG. 3, the trend line setting unit 11 sets, as the trend line, a linear function that passes from a point P1 (0, T1) at which the amount collected is zero and the time is when collection is started, and through a point P2 (S, T3) at which the amount collected is the daily scheduled amount to be collected S and the time is the end time T3 after the collection time has been extended. Setting information required for setting the trend line, or specifically, the start time T1, the daily scheduled amount to be collected S, and the post-extension amount collected time T3 are input via an input device or a terminal device (not shown in FIG. 2) by the administrator 40, for example.

In the example in FIG. 3, a linear function is set as the trend line because it can be assumed that a possible amount of work per unit time at the collection/loading station is fixed, and in an ideal state, the amount collected increases at a fixed pace from when collection of agricultural produce is started until the collection ends. However, in a case where a change in the possible amount of work per unit time at the collection station is known (see the following reference material), a curve may be used as the trend line.

### REFERENCE

material:http://ja.wikipedia.org/wiki/% E4% BD%9C%E6%A5%AD%E6%9B%B2%E7%B7%9A

In Embodiment 1, if a specific time point is designated as the time by the administrator 40, the estimation unit 12 specifies the amount of collected agricultural produce at the designated time from the amount collected output by the collection amount calculation unit 13. Specifically, if the administrator 40 designates the current time, the estimation unit 12 sets an output latest amount collected as the amount of collected agricultural produce at the designated time.

The estimation unit 12 then calculates a difference between the specified amount of collected agricultural produce and the amount to be collected on the trend line at the designated time, divides the calculated difference by the amount to be collected on the trend line, and sets the obtained value as a deviation ratio X. The deviation ratio X is, however, positive when the amount to be collected on the trend line is greater than the amount of collected agricultural produce.

Next, if the calculated deviation ratio X is positive, the estimation unit 12 compares the deviation ratio X with a preset threshold value. If the deviation ratio X is greater than the threshold value, the estimation unit 12 estimates that the agricultural produce will be insufficient. The estimation unit 12 also outputs the estimation result, and presents this to the administrator 40 via a display device or a terminal device (not shown in FIG. 2).

In the case of estimating that the agricultural produce will be insufficient, the estimation unit 12 can also make a warning notification indicating the shortage to a terminal 50 of a producer via a network such as the Internet (not shown in FIG. 2). In this case, the producer who has received the notification can quickly deal with the shortage in the amount collected.

### Operation of Apparatus

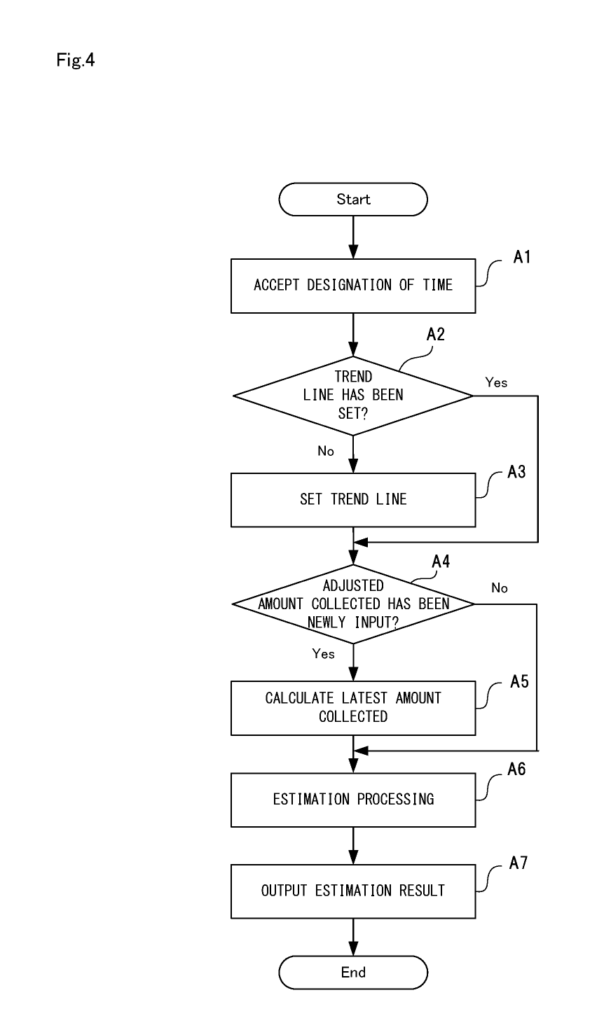

Next, operations of the collection amount regulation assist apparatus 10 according to Embodiment 1 of the present invention will be described using FIG. 4. FIG. 4 is a flowchart showing operations of the collection amount regulation assist apparatus according to Embodiment 1 of the present invention. In the following description, FIGS. 1 to 3 will be referenced where appropriate. In Embodiment 1, a collection amount regulation assist method is implemented by operating the collection amount regulation assist apparatus 10. Accordingly, a description of the collection amount regulation assist method according to Embodiment 1 will be replaced with the following description of the operation of the collection amount regulation assist apparatus 10.

Initially, as shown in FIG. 4, in the collection amount regulation assist apparatus 10, the estimation unit 12 accepts designation of a time by the administrator 40 (step A1). In this case, the estimation unit 12 notifies the trend line setting unit 11 and the collection amount calculation unit 13 that the designation of a time has been accepted.

Next, after executing step A1, the trend line setting unit 11 determines whether or not the trend line has been set (step A2). If the result of the determination in step A2 is that the trend line has been set, later-described step A4 is executed. On the other hand, if the result of the determination in step A2 is that the trend line has not been set, the trend line setting unit 11 sets the trend line (step A3). Specifically, the trend line setting unit 11 sets a linear function that passes from the point P1 and through the point P2 shown in FIG. 2 using the setting information that is input by the administrator 40.

Next, the collection amount calculation unit 13 determines whether or not an adjusted amount collected has been newly input by the administrator 40 (step A4). If the result of the determination in step A4 is that an adjusted amount collected has not been newly input, later-described step A6 is executed. On the other hand, if the result of the determination in step A4 is that an adjusted amount collected has been newly input, the collection amount calculation unit 13 calculates the latest amount collected (step A5). The collection amount calculation unit 13 also outputs the calculated latest amount collected to the estimation unit 12.

Next, the estimation unit 12 obtains the deviation ratio X at the time designated in step A1, and estimates whether or not the agricultural produce will be insufficient based on the obtained deviation ratio X (step A6).

Specifically, in step A6, the estimation unit 12 calculates a difference between the amount collected that is calculated in step A5 and the amount to be collected on the trend line at the designated time, divides the calculated difference by the amount to be collected on the trend line, and sets the obtained value as the deviation ratio X. If the calculated deviation ratio X is positive, the estimation unit 12 compares the deviation ratio X with a preset threshold value. If the deviation ratio X is greater than the threshold value, the estimation unit 12 estimates that the agricultural produce will be insufficient.

Thereafter, the estimation unit 12 outputs the result of the estimation processing in step A6 to a display device, or a terminal device of the administrator 40 (step A7). Thus, the estimation processing result is presented to the administrator 40. If the estimation unit 12 estimates that the agricultural produce will be insufficient, in step A7, the estimation unit 12 can also make a warning notification indicating that the agricultural produce will be insufficient to the terminal 50 of a producer. After the execution of step A7, the processing in the collection amount regulation assist apparatus 10 ends here.

Thereafter, if a new time is designated by the administrator 40, steps A1 to A7 are executed again. Accordingly, the administrator can check whether or not the amount to be collected will be insufficient, at any time until the post-extension end time T3 is reached.

Note that, in the example in FIG. 4, execution of the processing is triggered by the designation of a time by the administrator. However, Embodiment 1 is not limited to this mode. For example, Embodiment 1 may be carried out in a mode in which the processing is started at every preset time, or at preset time intervals. In this mode, steps A2 to A7 shown in FIG. 4 are executed at every preset time or at preset time intervals. Alternatively, execution of steps A2 to A7 shown in FIG. 4 may be triggered by a request being made by an external system.

### Program

A program according to Embodiment 1 of the present invention need only be a program that causes a computer to execute steps A1 to A7 shown in FIG. 4. By installing this program to a computer and executing it, the collection amount regulation assist apparatus 10 and the collection amount regulation assist method according to Embodiment 1 can be realized. In this case, a CPU (Central Processing Unit) of the computer functions as the trend line setting unit 11, the estimation unit 12, and the collection amount calculation unit 13, and performs the processing.

### Effects of Embodiment 1

As described above, according to Embodiment 1, the collection amount regulation assist apparatus 10 sets the trend line while giving consideration to a plurality of producers bringing agricultural produce to a collection/loading station, and determines whether or not the amount to be collected will be insufficient based on the set trend line. Therefore, with the collection amount regulation assist apparatus 10, the amount of collected agricultural produce can be predicted in a situation where the agricultural produce is brought to the collection/loading station by a plurality of producers. As a result, the occurrence of a problem due to a shortage in the amount collected and a problem due to an excessive amount collected described in the Background Art is suppressed.

### Modification 1 of Embodiment 1

As mentioned above, in the example shown in FIGS. 1 to 4, a linear function that passes from the point P1 and through the point P2 is set as the trend line. If it is estimated that the final amount to be collected will not reach the daily scheduled amount to be collected S, this estimation is presented to the administrator 40. However, Embodiment 1 is not limited to this example.

For example, in Embodiment 1, the trend line setting unit 11 can set a trend line that passes from the point P1 and through a point P3 (see FIG. 3) (hereinafter referred to as an “upper limit line”) in addition to, or in place of, the trend line that passes from the point P1 and through the point P2 (hereinafter referred to as a “lower limit line”). The point P3 is a point at which the amount collected is an amount that is the sum of the daily scheduled amount S and the storable amount ΔS, and the time is the end time T2.

Furthermore, the estimation unit 12 calculates a difference between the specified amount of collected agricultural produce and the amount to be collected on the upper limit line at the designated time, divides the calculated difference by the amount to be collected on the upper limit line, and sets the obtained value as the deviation ratio X. The deviation ratio X is positive when the amount of collected agricultural produce is greater than the amount to be collected on the upper line. If the calculated deviation ratio X is positive, the estimation unit 12 compares the deviation ratio X with a preset threshold value. If the deviation ratio X is greater than the threshold value, the estimation unit 12 estimates that the agricultural produce will be excessive.

Thus, in Modification 1, the upper limit line is set in addition to, or in place of, the lower limit line. Therefore, Modification 1 is effective particularly in a case where the amount delivered from producers is large and an excessive amount of agricultural produce is collected at the collection/loading station. The amount of agricultural produce to be disposed can be suppressed.

### Modification 2 of Embodiment 1

In Modification 2, each producer can notify, via the terminal 50, the collection amount regulation assist apparatus 10 of the amount of agricultural produce to be delivered to the collection/loading station. In this case, as a result of the administrator 40 inputting the amount of agricultural produce that does not satisfy certain standards, the collection amount calculation unit 13 can calculate the adjusted amount collected by subtracting the amount input by the administrator 40 from the amount to be delivered of which the collection amount regulation assist apparatus 10 was notified.

In a case where the collection amount regulation assist apparatus 10 is connected to an external system that records the adjusted amount collected, Embodiment 1 may be carried out in a mode in which the collection amount regulation assist apparatus 10 is automatically notified, by this system, of the adjusted amount collected.

### Embodiment 2

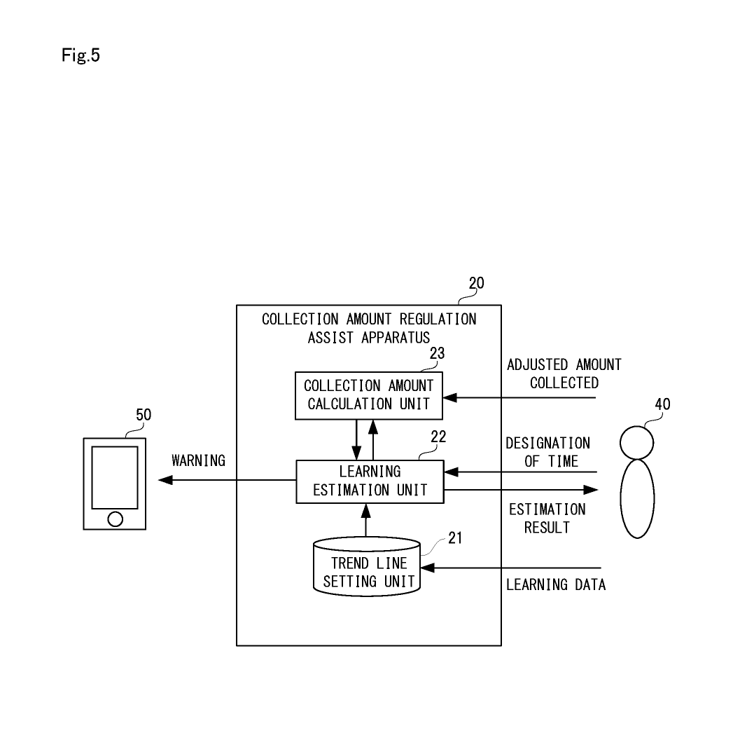

Next, a collection amount regulation assist apparatus, a collection amount regulation assist method, and a program according to Embodiment 2 of the present invention will be described with reference to FIGS. 5 to 9.

### Configuration of Apparatus

First, a configuration of the collection amount regulation assist apparatus according to Embodiment 2 of the present invention will be described using FIG. 5. FIG. 5 is a block diagram showing a specific configuration of the collection amount regulation assist apparatus according to Embodiment 2 of the present invention.

A collection amount regulation assist apparatus 20 according to Embodiment 2 shown in FIG. 5 is also an apparatus for assisting in regulation of the amount of agricultural produce collected at a collection/loading station, similar to the collection amount regulation assist apparatus 10 according to Embodiment 1 shown in FIGS. 1 and 2. However, in Embodiment 2, the collection amount regulation assist apparatus 20 is different from the collection amount regulation assist apparatus 10 in terms of configuration and function, as shown in FIG. 5. Differences therebetween will be mainly described below.

As shown in FIG. 5, the collection amount regulation assist apparatus 20 is provided with a learning data storing unit 21, a learning estimation unit 22, and a collection amount calculation unit 23. Of these units, the collection amount calculation unit 23 has a function similar to the function of the collection amount calculation unit 13 shown in FIG. 2 in Embodiment 1. That is to say, upon adjusted amounts collected from respective producers being input by the administrator 40, the collection amount calculation unit 23 adds up these amounts and calculates the latest amount collected. The collection amount calculation unit 23 also outputs the calculated latest amount collected to the learning estimation unit 22.

The learning estimation unit 22 first constructs a learning model of the deviation ratio X using the learning data stored in the learning data storing unit 21. The learning estimation unit 22 then applies the deviation ratio at a specific time point (time designated by the administrator 40) to the constructed learning model, and estimates whether or not the agricultural produce will be insufficient based on the result obtained thereby.

The learning data includes deviation ratios X at a plurality of time points from previous days that are calculated using the trend line, and a result indicating whether the amount of collected agricultural produce on each previous day was successfully or unsuccessfully regulated (hereinafter referred to as a “regulation result”). In Embodiment 2, the learning data is input by the administrator 40 and is stored in the learning data storing unit 21. Note that the trend line used for creating the learning data is also stored in the learning data storing unit 21.

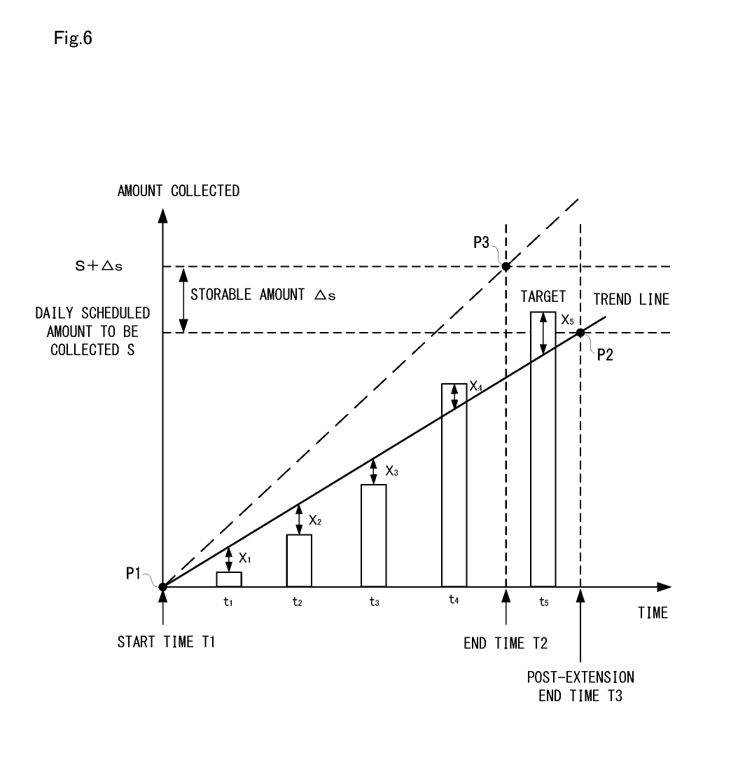

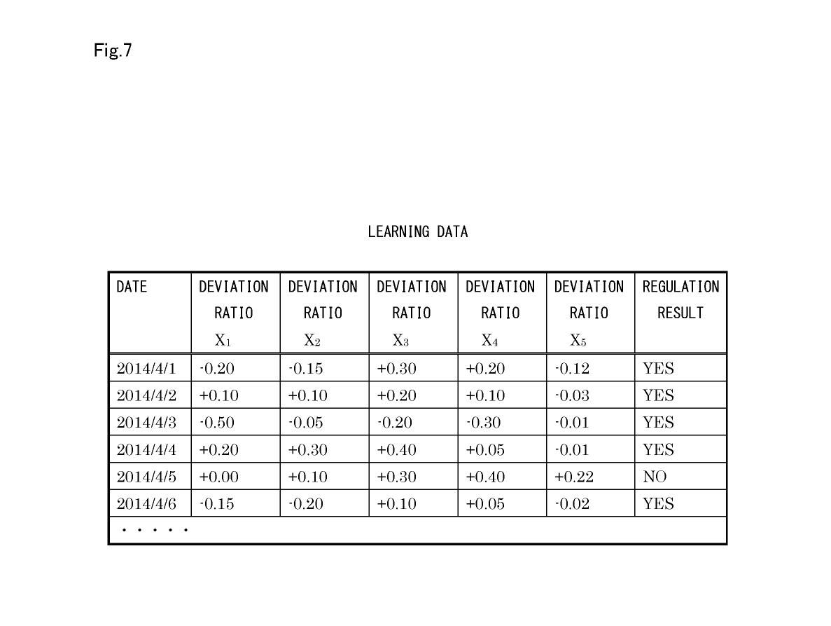

The learning data used in Embodiment 2 will now be specifically described using FIGS. 6 and 7. FIG. 6 is an illustrative diagram for illustrating a concept of the learning data used in Embodiment 2 of the present invention. FIG. 7 is a diagram showing a specific example of the learning data used in Embodiment 2 of the present invention.

A coordinate system shown in FIG. 6 is similar to the coordinate system shown in FIG. 2, and is a coordinate system using the amount collected and the time as two orthogonal axes. The trend line is also set similarly to the example in FIG. 2. The learning data is created by obtaining deviation ratios X₁ to X₅ at time t₁ to t₅ every day from the trend line and the amounts collected at the respective times, and storing the obtained deviation ratios X₁ to X₅ and the regulation result on the day in the learning data storing unit 21. Specifically, the learning data is as shown in FIG. 7. In FIG. 7, “YES” appears if the amount of collected agricultural produce was successfully regulated, and “NO” appears if the amount of collected agricultural produce was unsuccessfully regulated.

If the learning data shown in FIGS. 6 and 7 is created, the learning estimation unit 22 calculates a probability distribution with the deviation ratio as a variable regarding unsuccessful cases where the amount of collected agricultural produce was unsuccessfully regulated, using the deviation ratios included in the learning data. The calculated probability distribution serves as the learning model.

The learning estimation unit 22 then applies the deviation ratio at a specific time point to the calculated probability distribution, obtains, using a value obtained thereby, a posterior probability of the unsuccessful cases, and estimates whether or not the agricultural produce will be insufficient based on the obtained posterior probability.

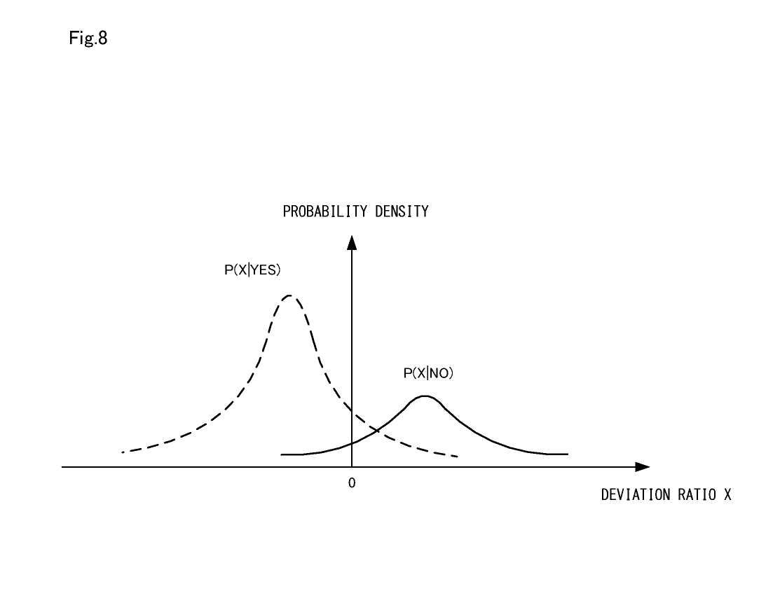

Subsequently, a case of using a Gaussian distribution as the probability distribution will be described using FIG. 8. FIG. 8 is an illustrative diagram for illustrating the learning data used in Embodiment 2 of the present invention.

Initially, the learning estimation unit 22 classifies the deviation ratios (X₁ to X₅) at the respective times into cases of YES and cases of NO, using the learning data. Next, the learning estimation unit 22 calculates an average μ and a variance σ² of the deviation ratios in the cases of YES and the deviation ratios in the cases of NO.

Then, as shown in FIG. 8, the learning estimation unit 22 calculates a Gaussian distribution P(X|YES) from the average μ and the variance σ² of the deviation ratios in the cases of YES, and also calculates a Gaussian distribution P(X|NO) from the average μ and the variance σ² of the deviation ratios in the cases of NO.

The learning estimation unit 22 also calculates a probability P(YES) that the amount collected will reach a target shown in FIG. 6, and a probability P(NO) that the amount collected will not reach the target shown in FIG. 6, using the learning data. The learning estimation unit 22 then constructs an equation of a posterior probability P(YES|X) for a case of an YES and an equation of the posterior probability P(NO|X) for a case of an NO using the calculated Gaussian distributions and probabilities.

The results are as indicated by Equations 1 and 2 below. In Equations 1 and 2 below, the deviation ratio X is a variable. “A” in Equations 1 and 2 below expresses a set that includes YES or NO as an element.

$$\begin{matrix}P ( YES \vert X ) = \frac{P ( X \vert YES ) \times P ( YES )}{{\sum }_{A}^{ } P ( X \vert A ) \times P ( A )} & [ Equation 1 ] \\ P ( NO \vert X ) = \frac{P ( X \vert NO ) \times P ( NO )}{{\sum }_{A}^{ } P ( X \vert A ) \times P ( A )} & [ Equation 2 ]\end{matrix}$$

Next, upon a specific time point being designated as the time by the administrator 40, the learning estimation unit 22 calculates the deviation ratio X at the designated time using the trend line stored in the learning data storing unit 21 and the latest amount collected that the collection amount calculation unit has notified of. The learning estimation unit 22 then substitutes the calculated deviation ratio X in Equations 1 and 2 above, and calculates the posterior probability P(YES|X) and the posterior probability P(NO|X).

Next, the learning estimation unit 22 compares the posterior probability P(NO|X) with a preset threshold value. If the posterior probability P(NO|X) exceeds the threshold value, the learning estimation unit 22 estimates that the agricultural produce will be insufficient. The learning estimation unit 22 then outputs the estimation result, and presents this to the administrator 40 via a display device or a terminal device (not shown in FIG. 2). At this time, the learning estimation unit 22 also presents the posterior probability P(YES|X) to the administrator 40 via the display device or the terminal device (not shown in FIG. 2). The posterior probability P(YES|X) serves as a scale of favorability of the collection amount regulation, and is useful for the administrator 40.

Note that, in the above description, a Gaussian distribution is used as a probability distribution. However, in Embodiment 2, the probability distribution is not limited to a Gaussian distribution. For example, if a histogram of the deviation ratio X can be more approximated using a Johnson SU distribution, a logistic distribution, or the like than using a Gaussian distribution, one of these distributions can be used as a probability distribution.

In the case of estimating that the agricultural produce will be insufficient, the learning estimation unit 22 can also make a warning notification indicating the shortage to the terminal 50 of a producer via a network such as the Internet (not shown in FIG. 5). In this case, the producer who has received the notification can quickly deal with the shortage in the amount collected.

As mentioned above, in the case where a producer is to be notified of the shortage in the amount collected, it is preferable that the learning data is created based on the amount collected excluding the amount added due to the notification. This is because an improvement in estimation accuracy can be expected by constructing the learning data from the amount of agricultural produce that is purely autonomously delivered by a producer (adjusted amount collected). Specifically, in this case, the regulation result in the case of excluding the amount added due to the notification, rather than the past actual regulation result, is used as a research result. The deviation ratios (X₁ to X₅) at the respective times in the learning data are calculated from the amount collected excluding the amount added due to the notification.

### Operation of Apparatus

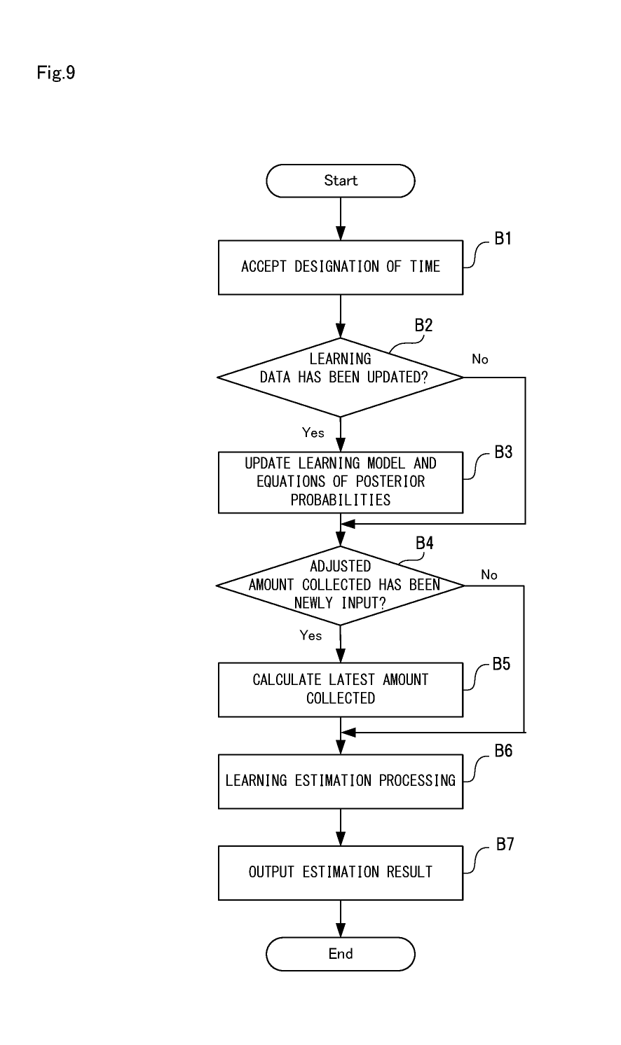

Next, operations of the collection amount regulation assist apparatus 20 according to Embodiment 2 of the present invention will be described using FIG. 9. FIG. 9 is a flowchart showing operations of the collection amount regulation assist apparatus according to Embodiment 2 of the present invention. In the following description, FIGS. 5 to 8 will be referenced where necessary. In Embodiment 2, a collection amount regulation assist method is implemented by operating the collection amount regulation assist apparatus 20. Accordingly, a description of the collection amount regulation assist method according to Embodiment 2 will be replaced with the following description of the operation of the collection amount regulation assist apparatus 20.

Initially, in the collection amount regulation assist apparatus 20, the learning estimation unit 22 accepts designation of a time by the administrator 40, as shown in FIG. 9 (step B1). In this case, the learning estimation unit 12 notifies the collection amount calculation unit 23 that the designation of a time has been accepted.

Next, the learning estimation unit 22 determines whether or not the learning data stored in the learning data storing unit 21 has been updated (step B2). If the result of the determination in step B2 is that the learning data has not been updated, later-described step B4 is executed. On the other hand, if the result of the determination in step B2 is that the learning data has been updated, the learning estimation unit 22 recalculates the Gaussian distribution P(X|YES) and the Gaussian distribution P(X|NO) to update the learning model (step B3).

Furthermore, in step B3, the learning estimation unit 22 updates both the equation of the posterior probability P(YES|X) shown above as Equation 1 and the equation of the posterior probability P(NO|X) shown above as Equation 2, using the updated Gaussian distributions.

Next, the collection amount calculation unit 23 determines whether or not an adjusted amount collected has been newly input by the administrator 40 (step B4). If the result of the determination in step B4 is that an adjusted amount collected has not been newly input, later-described step B6 is executed. On the other hand, if the result of the determination in step B4 is that an adjusted amount collected has been newly input, the collection amount calculation unit 23 calculates the latest amount collected (step B5). The collection amount calculation unit 13 also outputs the calculated latest amount collected to the learning estimation unit 22. Steps B4 and B5 are similar respectively to steps A4 and A5 shown in FIG. 4.

Next, the learning estimation unit 22 estimates whether or not the agricultural produce will be insufficient (step B6). Specifically, in step B6, the estimation unit 12 calculates the deviation ratio X at the designated time using the amount collected that is calculated in step B5 and the trend line stored in the learning data storing unit 21. The learning estimation unit 22 then substitutes the calculated deviation ratio X in Equations 1 and 2 above, and calculates the posterior probability P(YES|X) and the posterior probability P(NO|X). Furthermore, if the calculated posterior probability P(NO|X) exceeds the threshold value, the learning estimation unit 22 estimates that the agricultural produce will be insufficient.

Thereafter, the learning estimation unit 22 outputs the result of the estimation processing in step B6 to a display device, or a terminal device of the administrator 40 (step B7). Thus, the estimation processing result is presented to the administrator 40. In the case of estimating that the agricultural produce will be insufficient, in step B7, the learning estimation unit 22 can also make a warning notification indicating that the agricultural produce will be insufficient to the terminal 50 of a producer. After the execution of step B7, the processing in the collection amount regulation assist apparatus 20 ends here.

Thereafter, if a new time is designated by the administrator 40, steps B1 to B7 are executed again. Accordingly, the administrator can check whether or not the amount to be collected will be insufficient, at any time until the post-extension end time T3 is reached.

Note that, in the example in FIG. 9, the execution of the processing is triggered by the designation of a time by the administrator. However, Embodiment 2 is not limited to this mode. For example, Embodiment 2 may be carried out in a mode in which the processing is started at every preset time, or at preset time intervals. In this mode, steps B2 to B7 shown in FIG. 9 are executed at every preset time or at preset time intervals. Alternatively, execution of steps B2 to B7 shown in FIG. 9 may be triggered by a request being made by an external system.

### Program

A program according to Embodiment 2 of the present invention need only be a program that causes a computer to execute steps B1 to B7 shown in FIG. 9. By installing this program to a computer and executing it, the collection amount regulation assist apparatus 20 and the collection amount regulation assist method according to Embodiment 2 can be realized. In this case, a CPU (Central Processing Unit) of the computer functions as the learning estimation unit 22 and the collection amount calculation unit 23, and performs the processing.

### Effects of Embodiment 2

As described above, according to Embodiment 2, the collection amount regulation assist apparatus 20 learns the increasing trend in the amount collected in a case where a plurality of producers bring agricultural produce to a collection/loading station, and determines whether or not the amount to be collected will be insufficient using the learning result. Therefore, in a case of using the collection amount regulation assist apparatus 20 as well, the amount of collected agricultural produce can be predicted in a situation where the agricultural produce is brought to the collection/loading station by a plurality of producers. As a result, the occurrence of a problem due to a shortage in the amount collected and a problem due to an excessive amount collected described in the Background Art is suppressed.

### Modification 1 of Embodiment 2

As mentioned above, in the example shown in FIGS. 5 to 9, a linear function that passes from the point P1 and through the point P2 is used as the trend line that serves as a basis for the learning data. However, Embodiment 2 is not limited to this example.

For example, in Embodiment 2, the learning data may be created using a trend line that passes from the point P1 and through a point P3 (see the diagrams) (hereinafter referred to as an “upper limit line”) in addition to, or in place of, the trend line that passes from the point P1 and through the point P2 (hereinafter referred to as a “lower limit line”). The point P3 is a point at which the amount collected is an amount that is the sum of the daily scheduled amount S and the storable amount ΔS, and the time is the end time T2.

Thus, in Modification 1, the learning data is created using the upper limit line. Therefore, Modification 1 is effective particularly in a case where the amount delivered by producers is large and an excessive amount of agricultural produce is collected at the collection/loading station, and the amount of agricultural produce to be disposed can be suppressed.

### Modification 2 of Embodiment 2

Modification 2 of Embodiment 1 is applicable to Embodiment 2. That is to say, Embodiment 2 may also be carried out in a mode in which each producer can notify, via the terminal 50, the collection amount regulation assist apparatus 10 of the amount of agricultural produce to be delivered to the collection/loading station. In a case where the collection amount regulation assist apparatus 20 is connected to an external system that records the adjusted amount collected, Embodiment 2 may also be carried out in a mode in which the collection amount regulation assist apparatus 20 is automatically notified of the adjusted amount collected from this system.

### Embodiment 3

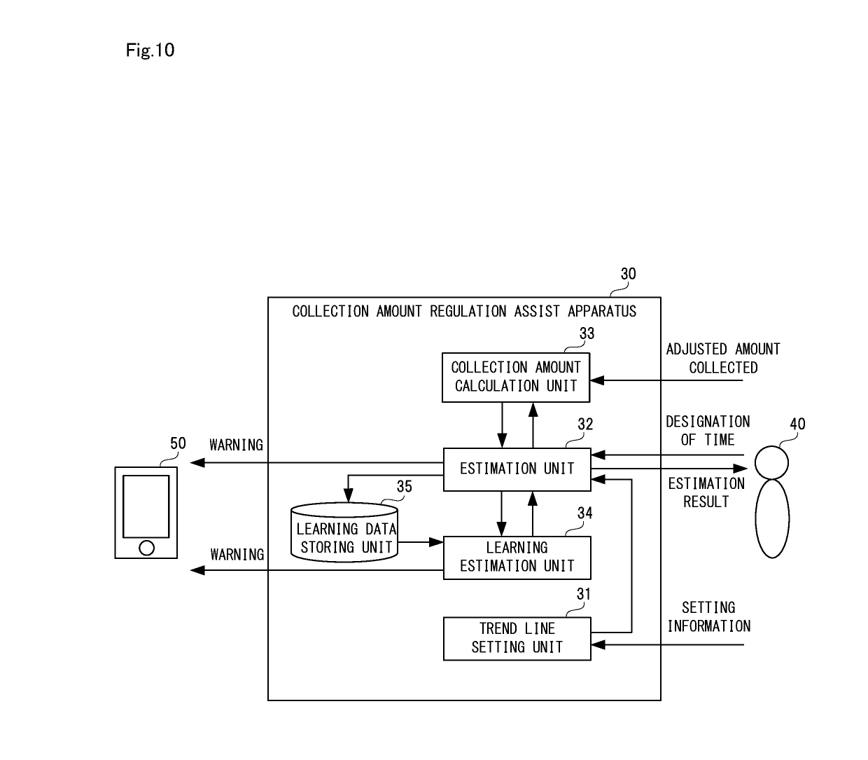

Next, a collection amount regulation assist apparatus, a collection amount regulation assist method, and a program according to Embodiment 3 of the present invention will be described with reference to FIG. 10. FIG. 10 is a block diagram showing a specific configuration of the collection amount regulation assist apparatus according to Embodiment 3 of the present invention.

A collection amount regulation assist apparatus 30 according to Embodiment 3 shown in FIG. 10 is also an apparatus for assisting in regulation of the amount of agricultural produce collected at the collection/loading station, similar to the collection amount regulation assist apparatus 10 according to Embodiment 1 and the collection amount regulation assist apparatus 20 according to Embodiment 2. However, in Embodiment 3, the collection amount regulation assist apparatus 30 includes the functions of the collection amount regulation assist apparatus 10 and the collection amount regulation assist apparatus 20. A specific description will be given below.

As shown in FIG. 10, the collection amount regulation assist apparatus 30 includes a trend line setting unit 31, an estimation unit 32, a collection amount regulation unit 33, a learning estimation unit 34, and a learning data storing unit 35. Of these units, the trend line setting unit 31 has a function similar to the function of the trend line setting unit 11 shown in FIG. 2 in Embodiment 1. The trend line setting unit 31 sets a trend line based on setting information that is input by the administrator 40.

Also, the collection amount calculation unit 33 has a function similar to the function of the collection amount calculation unit 13 shown in FIG. 2 in Embodiment 1. Upon adjusted amounts collected from respective producers being input by the administrator 40, the collection amount calculation unit 33 adds up these amounts to calculate a latest adjusted amount collected, and outputs the calculated latest adjusted amount collected to the estimation unit 32.

Furthermore, the estimation unit 32 also has a function similar to the function of the estimation unit 12 shown in FIG. 2 in Embodiment 1. If a specific time point is designated as the time by the administrator 40, the estimation unit 32 specifies the amount of collected agricultural produce at the designated time from the latest amount collected that the collection amount calculation unit 33 has notified of. The estimation unit 32 then calculates a deviation ratio X at the designated time from the specified amount of collected agricultural produce and the amount to be collected on the trend line at this time, and estimates whether the agricultural produce will be insufficient using the calculated deviation ratio X. The estimation unit 32 also outputs the estimation result and presents this to the administrator 40 via a display device or a terminal device (not shown in FIG. 2).

However, in Embodiment 3, the estimation unit 32 also has a function of creating the learning data shown in FIG. 7 in Embodiment 2, unlike the estimation unit 12. Specifically, the estimation unit 32 calculates the deviation ratio X at every preset time on a day when shipment is conducted at the collection/loading station, and stores the calculated deviation ratios X as the learning data in the learning data storing unit 35.

After the post-extension end time T3 has been reached, the estimation unit 32 also determines whether or not the latest amount collected has reached a target (see FIG. 6). If the result of the determination is that the target has been reached, the estimation unit 32 adds YES to the learning data on the corresponding day. If the target has not been reached, the estimation unit 32 adds NO to the learning data on the corresponding day.

The learning estimation unit 34 has a function similar to the function of the learning estimation unit 22 shown in FIG. 5 in Embodiment 2. That is to say, the learning estimation unit 34 first constructs a learning model of the deviation ratio X using the learning data stored in the learning data storing unit 35. Upon the administrator designating a time, the learning estimation unit 34 applies the deviation ratio at the designated time to the constructed learning model, and estimates whether or not the agricultural produce will be insufficient based on the result obtained thereby.

Thus, in Embodiment 3, the learning data is automatically created by the estimation unit 32. Therefore, the administrator 40 does not need to create and input the learning data. Also, in Embodiment 3, both steps A1 to A7 shown in FIG. 4 and steps B1 to B7 shown in FIG. 9 can be executed. Therefore, both the estimation result calculated from the deviation ratio X and the estimation result obtained using the learning data can be presented to the administrator 40. This allows the administrator 40 to readily and successfully regulate the amount collected.

In Embodiment 3, in the case of estimating that the agricultural produce will be insufficient, the estimation unit 32 and the learning estimation unit 34 can also make a warning notification indicating the shortage to the terminal 50 of a producer via a network such as the Internet (not shown in FIG. 10). In this case, the producer who has received the notification can quickly deal with the shortage in the amount collected.

In the case where a producer is notified of the shortage in the amount collected as mentioned above, the estimation unit 32 can create the learning data based on the amount collected excluding the amount added due to the notification. In this case as well, similar to Embodiment 2, the regulation result in the case of excluding the amount added due to the notification, rather than the past actual regulation result, is used as a research result. The deviation ratios (X₁ to X₅) at the respective times in the learning data are calculated from the amount collected excluding the amount added due to the notification. Note that, in this case, the amount of the agricultural produce added due to the notification is input by the administrator 40 via an input device or a terminal device (not shown in FIG. 10), for example.

### Operation of Apparatus

In Embodiment 3, as a result of one of or both steps A1 to A7 shown in FIG. 4 and steps B1 to B7 shown in FIG. 9 being executed, the collection amount regulation assist method according to Embodiment 3 is executed. In addition, in Embodiment 3, the learning data is generated every day. Therefore, a step of calculating, in advance, the deviation ratio X at every time, a step of determining whether or not the latest amount collected has reached the target at the end time T3, and a step of storing the calculation result and the determination result are executed.

### Program

A program according to Embodiment 3 of the present invention need only be a program that causes a computer to execute steps A1 to A7 shown in FIG. 4 and steps B1 to B7 shown in FIG. 9. By installing this program to a computer and executing it, the collection amount regulation assist apparatus 30 and the collection amount regulation assist method according to Embodiment 3 can be realized. In this case, a CPU (Central Processing Unit) of the computer functions as the trend line setting unit 31, the estimation unit 32, the end calculation unit 33, and the learning estimation unit 34, and performs the processing.

### Physical Configuration of Apparatus

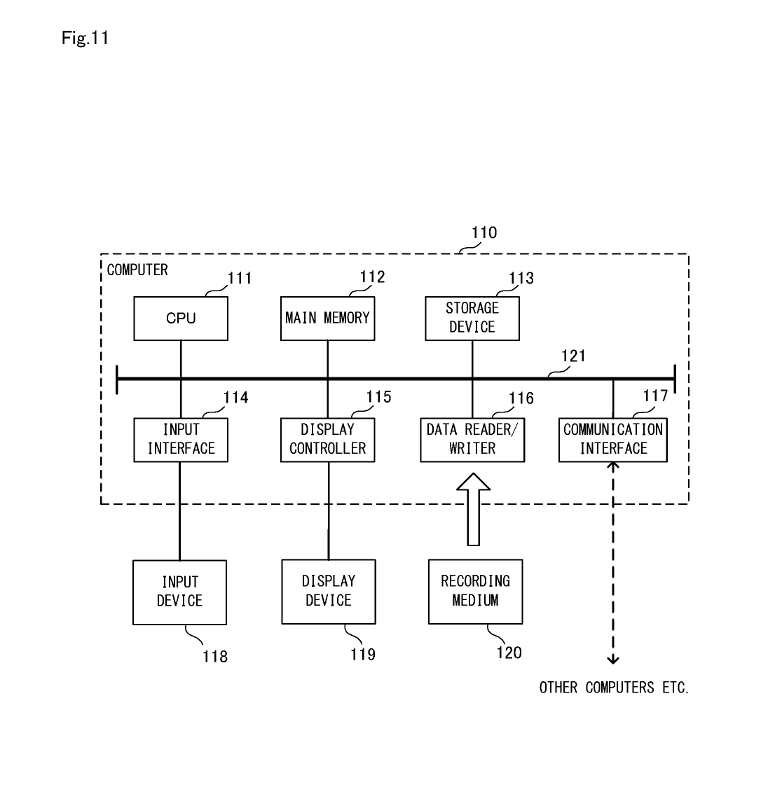

A description will now be given, using FIG. 11, of a computer that realizes the collection amount regulation assist apparatus by executing the programs according to Embodiments 1 to 3. FIG. 11 is a block diagram showing an example of a computer that realizes the collection amount regulation assist apparatuses according to Embodiments 1 to 3 of the present invention.

As shown in FIG. 11, a computer 110 includes a CPU 111, a main memory 112, a storage device 113, an input interface 114, a display controller 115, a data reader/writer 116, and a communication interface 117. These parts are connected to each other via a bus 121 so as to be able to communicate data.

The CPU 111 carries out various calculations by loading, to the main memory 112, the programs (codes) according to the above embodiments stored in the storage device 113 and executing them in a given order. The main memory 112 typically is a volatile storage device such as a DRAM (Dynamic Random Access Memory). The programs according to the above embodiments are provided in a state of being stored in a computer-readable recording medium 120. Note that the programs according to the above embodiments may be distributed on the Internet to which the computer 110 is connected via the communication interface 117.

Specific examples of the storage device 113 include a hard disk as well as a semiconductor storage device such as a flash memory. The input interface 114 mediates data transmission between the CPU 111 and an input device 118 such as a keyboard or a mouse. The display controller 115 is connected to a display device 119 and controls the display on the display device 119. The data reader/writer 116 mediates data transmission between the CPU 111 and the recording medium 120, reads out the programs from the recording medium 120, and writes, in the recording medium 120, the results of processing performed in the computer 110. The communication interface 117 mediates data transmission between the CPU 111 and other computers.

Specific examples of the recording medium 120 include general-purpose semiconductor storage devices such as a CF (Compact Flash (registered trademark) and an SD (Secure Digital), magnetic storage media such as a flexible disk, and an optical storage media such as a CD-ROM (Compact Disk Read Only Memory).

Part or all of the above-described embodiments can be expressed by Supplementary Note 1 to Supplementary Note 30 below, but are not limited thereto.

(Supplementary Note 1)

An apparatus for assisting in regulation of an amount of agricultural produce collected at a collection/loading station, including:

a trend line setting unit for setting a trend line indicating an ideal change in an amount of the agricultural produce to be collected from when collection of the agricultural produce is started until the collection ends, using a scheduled amount of the agricultural produce to be collected per day; and

an estimation unit for obtaining a deviation ratio indicating a degree of deviation in an amount of the agricultural produce that has been collected from the trend line at a specific time point, and estimating, based on the obtained deviation ratio, whether or not the agricultural produce will be insufficient.

(Supplementary Note 2)

The collection amount regulation assist apparatus according to Supplementary Note 1, further including:

a learning estimation unit for constructing a learning model of the deviation ratio by using deviation ratios at a plurality of time points from previous days and a regulation result indicating whether the amount of the collected agricultural produce on a corresponding day was successfully or unsuccessfully regulated, applying the deviation ratio at the specific time point to the constructed learning model, and, based on a thus obtained result, estimating whether or not the agricultural produce will be insufficient.

(Supplementary Note 3)

The collection amount regulation assist apparatus according to Supplementary Note 2,

wherein the learning estimation unit

constructs the learning model by calculating, using the deviation ratios from previous days, a probability distribution with the deviation ratio as a variable regarding unsuccessful cases where the amount of the collected agricultural produce was unsuccessfully regulated,

applies the deviation ratio at the specific time point to the calculated probability distribution and obtains, using a value that is obtained thereby, a posterior probability regarding the unsuccessful cases, and

estimates whether or not the agricultural produce will be insufficient based on the obtained posterior probability.

(Supplementary Note 4)

The collection amount regulation assist apparatus according to Supplementary Note 1,

wherein the trend line setting unit sets, as the trend line, a linear function in a coordinate system having an amount collected and time as two orthogonal axes, the linear function passing from a first point at which the amount collected is zero and the time is a collection start time, and through a second point at which the amount collected is the scheduled amount to be collected and the time is a collection end time.

(Supplementary Note 5)

The collection amount regulation assist apparatus according to Supplementary Note 1,

wherein, if the estimation unit estimates that the agricultural produce will be insufficient, the estimation unit notifies an external terminal designated in advance that the agricultural produce will be insufficient.

(Supplementary Note 6)

The collection amount regulation assist apparatus according to Supplementary Note 1,

wherein, if the learning estimation unit estimates that the agricultural produce will be insufficient, the learning estimation unit notifies an external terminal designated in advance that the agricultural produce will be insufficient.

(Supplementary Note 7)

An apparatus for assisting in regulation of an amount of agricultural produce collected at a collection/loading station, including:

a learning estimation unit for constructing a learning model of a deviation ratio by using learning data, applying the deviation ratio at a specific time point to the constructed learning model, and estimating whether or not the agricultural produce will be insufficient based on a thus obtained result,

wherein the learning data includes:

the deviation ratio calculated using a trend line that is set using a scheduled amount of the agricultural produce to be collected per day and indicates an ideal change in an amount of the agricultural produce to be collected from when collection of the agricultural produce is started until the collection ends, the deviation ratio indicating a degree of deviation in an amount of the agricultural produce that has been collected from the trend line at a plurality of time points on previous days; and

a regulation result indicating whether the amount of the collected agricultural produce on a corresponding day was successfully or unsuccessfully regulated.

(Supplementary Note 8)

The collection amount regulation assist apparatus according to Supplementary Note 7,

wherein the learning estimation unit

constructs the learning model by calculating, using the deviation ratio included in the learning data, a probability distribution with the deviation ratio as a variable regarding unsuccessful cases where the amount of the collected agricultural produce was unsuccessfully regulated,

applies the deviation ratio at the specific time point to the calculated probability distribution, and obtains, using a value that is obtained thereby, a posterior probability regarding the unsuccessful cases, and

estimates whether or not the agricultural produce will be insufficient based on the obtained posterior probability.

(Supplementary Note 9)

The collection amount regulation assist apparatus according to Supplementary Note 7,

wherein a linear function in a coordinate system having an amount collected and time as two orthogonal axes is set as the trend line, the linear function passing from a first point at which the amount collected is zero and the time is a collection start time, and through a second point at which the amount collected is the scheduled amount to be collected and the time is a collection end time.

(Supplementary Note 10)

The collection amount regulation assist apparatus according to Supplementary Note 7,

wherein, if the learning estimation unit estimates that the agricultural produce will be insufficient, the learning estimation unit notifies an external terminal designated in advance that the agricultural produce will be insufficient.

(Supplementary Note 11)

A method for assisting in regulation of an amount of agricultural produce collected at a collection/loading station, including:

a step (a) of setting a trend line indicating an ideal change in an amount of the agricultural produce to be collected from when collection of the agricultural produce is started until the collection ends, using a scheduled amount of the agricultural produce to be collected per day; and

a step (b) of obtaining a deviation ratio indicating a degree of deviation in an amount of the agricultural produce that has been collected from the trend line at a specific time point, and estimating, based on the obtained deviation ratio, whether or not the agricultural produce will be insufficient.

(Supplementary Note 12)

The collection amount regulation assist method according to Supplementary Note 11, further including:

a step (c) of constructing a learning model of the deviation ratio by using deviation ratios at a plurality of time points from previous days and a regulation result indicating whether the amount of the collected agricultural produce on a corresponding day was successfully or unsuccessfully regulated, applying the deviation ratio at the specific time point to the constructed learning model, and, based on a thus obtained result, estimating whether or not the agricultural produce will be insufficient.

(Supplementary Note 13)

The collection amount regulation assist method according to Supplementary Note 12,

wherein, in the step (c), the learning model is constructed by calculating, using the deviation ratios from previous days, a probability distribution with the deviation ratio as a variable regarding unsuccessful cases where the amount of the collected agricultural produce was unsuccessfully regulated,

the deviation ratio at the specific time point is applied to the calculated probability distribution, and a posterior probability regarding the unsuccessful cases is obtained using a value that is obtained thereby, and

it is estimated whether or not the agricultural produce will be insufficient based on the obtained posterior probability.

(Supplementary Note 14)

The collection amount regulation assist method according to Supplementary Note 11,

wherein, in the step (a), a linear function in a coordinate system having an amount collected and time as two orthogonal axes is set as the trend line, the linear function passing from a first point at which the amount collected is zero and the time is a collection start time, and through a second point at which the amount collected is the scheduled amount to be collected and the time is a collection end time.

(Supplementary Note 15)

The collection amount regulation assist method according to Supplementary Note 11, further including:

a step (d) of notifying an external terminal designated in advance that the agricultural produce will be insufficient if it is estimated in the step (b) that the agricultural produce will be insufficient.

(Supplementary Note 16)

The collection amount regulation assist method according to Supplementary Note 11, further including:

a step (e) of notifying an external terminal designated in advance that the agricultural produce will be insufficient if it is estimated in the step (c) that the agricultural produce will be insufficient.

(Supplementary Note 17)

A method for assisting in regulation of an amount of agricultural produce collected at a collection/loading station, including:

a step (a) of constructing a learning model of a deviation ratio by using learning data, applying the deviation ratio at a specific time point to the constructed learning model, and estimating whether or not the agricultural produce will be insufficient based on a thus obtained result,

wherein the learning data includes:

the deviation ratio calculated using a trend line that is set using a scheduled amount of the agricultural produce to be collected per day and indicates an ideal change in an amount of the agricultural produce to be collected from when collection of the agricultural produce is started until the collection ends, the deviation ratio indicating a degree of deviation in an amount of the agricultural produce that has been collected from the trend line at a plurality of time points on previous days; and

a regulation result indicating whether the amount of the collected agricultural produce on a corresponding day was successfully or unsuccessfully regulated.

(Supplementary Note 18)

The collection amount regulation assist method according to Supplementary Note 17,

wherein, in the step (a), the learning model is constructed by calculating, using the deviation ratio included in the learning data, a probability distribution with the deviation ratio as a variable regarding unsuccessful cases where the amount of the collected agricultural produce was unsuccessfully regulated,

the deviation ratio at the specific time point is applied to the calculated probability distribution, and a posterior probability regarding the unsuccessful cases is obtained using a value that is obtained thereby, and

it is estimated whether or not the agricultural produce will be insufficient based on the obtained posterior probability.

(Supplementary Note 19)

The collection amount regulation assist method according to Supplementary Note 17,

wherein a linear function in a coordinate system having an amount collected and time as two orthogonal axes is set as the trend line, the linear function passing from a first point at which the amount collected is zero and the time is a collection start time, and through a second point at which the amount collected is the scheduled amount to be collected and the time is a collection end time.

(Supplementary Note 20)

The collection amount regulation assist method according to Supplementary Note 17, further including:

a step (b) of notifying an external terminal designated in advance that the agricultural produce will be insufficient if it is estimated in the step (a) that the agricultural produce will be insufficient.

(Supplementary Note 21)

A computer-readable recording medium storing a program for assisting, using a computer, in regulation of an amount of agricultural produce collected at a collection/loading station, the program including a command for causing the computer to execute:

a step (a) of setting a trend line indicating an ideal change in an amount of the agricultural produce to be collected from when collection of the agricultural produce is started until the collection ends, using a scheduled amount of the agricultural produce to be collected per day; and

a step (b) of obtaining a deviation ratio indicating a degree of deviation in an amount of the agricultural produce that has been collected from the trend line at a specific time point, and estimating, based on the obtained deviation ratio, whether or not the agricultural produce will be insufficient.

(Supplementary Note 22)

The computer-readable recording medium according to Supplementary Note 21, wherein the program further includes a command for causing the computer to execute:

a step (c) of constructing a learning model of the deviation ratio by using deviation ratios at a plurality of time points from previous days and a regulation result indicating whether the amount of the collected agricultural produce on a corresponding day was successfully or unsuccessfully regulated, applying the deviation ratio at the specific time point to the constructed learning model, and, based on a thus obtained result, estimating whether or not the agricultural produce will be insufficient.

(Supplementary Note 23)

The computer-readable recording medium according to Supplementary Note 22,

wherein, in the step (c), the learning model is constructed by calculating, using the deviation ratios from previous days, a probability distribution with the deviation ratio as a variable regarding unsuccessful cases where the amount of the collected agricultural produce was unsuccessfully regulated,

the deviation ratio at the specific time point is applied to the calculated probability distribution, and a posterior probability regarding the unsuccessful cases is obtained using a value that is obtained thereby, and

it is estimated whether or not the agricultural produce will be insufficient based on the obtained posterior probability.

(Supplementary Note 24)

The computer-readable recording medium according to Supplementary Note 21,

wherein, in the step (a), a linear function in a coordinate system having an amount collected and time as two orthogonal axes is set as the trend line, the linear function passing from a first point at which the amount collected is zero and the time is a collection start time, and through a second point at which the amount collected is the scheduled amount to be collected and the time is a collection end time.

(Supplementary Note 25)

The computer-readable recording medium according to Supplementary Note 21, wherein the program further includes a command for causing the computer to execute:

a step (d) of notifying an external terminal designated in advance that the agricultural produce will be insufficient if it is estimated in step (b) that the agricultural produce will be insufficient.

(Supplementary Note 26)

The computer-readable recording medium according to Supplementary Note 21, wherein the program further includes a command for causing the computer to execute:

a step (e) of notifying an external terminal designated in advance that the agricultural produce will be insufficient if it is estimated in step (c) that the agricultural produce will be insufficient.

(Supplementary Note 27)

A computer-readable recording medium storing a program for assisting, using a computer, in regulation of an amount of agricultural produce collected at a collection/loading station, the program including a command for causing the computer to execute:

a step (a) of constructing a learning model of a deviation ratio by using learning data, applying the deviation ratio at a specific time point to the constructed learning model, and estimating whether or not the agricultural produce will be insufficient based on a thus obtained result,

wherein the learning data includes:

the deviation ratio calculated using a trend line that is set using a scheduled amount of the agricultural produce to be collected per day and indicates an ideal change in an amount of the agricultural produce to be collected from when collection of the agricultural produce is started until the collection ends, the deviation ratio indicating a degree of deviation in an amount of the agricultural produce that has been collected from the trend line at a plurality of time points on previous days; and

a regulation result indicating whether the amount of the collected agricultural produce on a corresponding day was successfully or unsuccessfully regulated.

(Supplementary Note 28)

The computer-readable recording medium according to Supplementary Note 27,

wherein, in the step (a), the learning model is constructed by calculating, using the deviation ratio included in the learning data, a probability distribution with the deviation ratio as a variable regarding unsuccessful cases where the amount of the collected agricultural produce was unsuccessfully regulated,

the deviation ratio at the specific time point is applied to the calculated probability distribution, and a posterior probability regarding the unsuccessful cases is obtained using a value that is obtained thereby, and

it is estimated whether or not the agricultural produce will be insufficient based on the obtained posterior probability.

(Supplementary Note 29)

The computer-readable recording medium according to Supplementary Note 27,

wherein a linear function in a coordinate system having an amount collected and time as two orthogonal axes is set as the trend line, the linear function passing from a first point at which the amount collected is zero and the time is a collection start time, and through a second point at which the amount collected is the scheduled amount to be collected and the time is a collection end time.

(Supplementary Note 30)

The computer-readable recording medium according to Supplementary Note 27, wherein the program further includes a command for causing the computer to execute:

a step (b) of notifying an external terminal designated in advance that the agricultural produce will be insufficient if it is estimated in the step (a) that the agricultural produce will be insufficient.

Although the invention of the present application has been described above with reference to the embodiments, the invention of the present application is not limited to the above-described embodiments. The configurations and details of the invention of the present application may be subjected to various modifications that can be understood by those skilled in the art within the scope of the invention of the present application.

This application claims the benefit of priority based on Japanese Patent Application No. 2014-140870 filed on Jul. 8, 2014, the entire disclosure of which is incorporated herein by reference.

### INDUSTRIAL APPLICABILITY

According to the present invention, even in a case where agricultural produce is brought to a collection/loading station by a plurality of producers, the amount of collected agricultural produce can be predicted. The present invention is useful in the field of agriculture.

### REFERENCE SIGNS LIST

10 Collection amount regulation assist apparatus (Embodiment 1)
11 Trend line setting unit
12 Estimation unit
13 Collection amount calculation unit
20 Collection amount regulation assist apparatus (Embodiment 2)
21 Learning data storing unit
22 Learning estimation unit
23 Collection amount calculation unit
30 Collection amount regulation assist apparatus (Embodiment 3)
31 Trend line setting unit
32 Estimation unit
33 Collection amount calculation unit
34 Learning estimation unit
35 Learning data storing unit
40 Administrator
50 Producer's terminal
110 Computer
111 CPU
112 Main memory
113 Storage device
114 Input interface
115 Display controller
116 Data reader/writer
117 Communication interface
118 Input device
119 Display device
120 Recording medium
121 Bus

What is claimed is:

1. An apparatus for assisting in regulation of an amount of agricultural produce collected at a collection/loading station, comprising:
a trend line setting unit for setting a trend line indicating an ideal change in an amount of the agricultural produce to be collected from when collection of the agricultural produce is started until the collection ends, using a scheduled amount of the agricultural produce to be collected per day; and
an estimation unit for obtaining a deviation ratio indicating a degree of deviation in an amount of the agricultural produce that has been collected from the trend line at a specific time point, and estimating, based on the obtained deviation ratio, whether or not the agricultural produce will be insufficient.

2. The collection amount regulation assist apparatus according to claim 1, further comprising:
a learning estimation unit for constructing a learning model of the deviation ratio by using deviation ratios at a plurality of time points from previous days and a regulation result indicating whether the amount of the collected agricultural produce on a corresponding day was successfully or unsuccessfully regulated, applying the deviation ratio at the specific time point to the constructed learning model, and, based on a thus obtained result, estimating whether or not the agricultural produce will be insufficient.

3. The collection amount regulation assist apparatus according to claim 2,
wherein the learning estimation unit
constructs the learning model by calculating, using the deviation ratios from previous days, a probability distribution with the deviation ratio as a variable regarding unsuccessful cases where the amount of the collected agricultural produce was unsuccessfully regulated,
applies the deviation ratio at the specific time point to the calculated probability distribution and obtains, using a value that is obtained thereby, a posterior probability regarding the unsuccessful cases, and
estimates whether or not the agricultural produce will be insufficient based on the obtained posterior probability.

4. The collection amount regulation assist apparatus according to claim 1,
wherein the trend line setting unit sets, as the trend line, a linear function in a coordinate system having an amount collected and time as two orthogonal axes, the linear function passing from a first point at which the amount collected is zero and the time is a collection start time, and through a second point at which the amount collected is the scheduled amount to be collected and the time is a collection end time.

5. The collection amount regulation assist apparatus according to claim 1,
wherein, if the estimation unit estimates that the agricultural produce will be insufficient, the estimation unit notifies an external terminal designated in advance that the agricultural produce will be insufficient.

6. The collection amount regulation assist apparatus according to claim 2,
wherein, if the learning estimation unit estimates that the agricultural produce will be insufficient, the learning estimation unit notifies an external terminal designated in advance that the agricultural produce will be insufficient.

7. An apparatus for assisting in regulation of an amount of agricultural produce collected at a collection/loading station, comprising:
a learning estimation unit for constructing a learning model of a deviation ratio by using learning data, applying the deviation ratio at a specific time point to the constructed learning model, and estimating whether or not the agricultural produce will be insufficient based on a thus obtained result,
wherein the learning data includes:
the deviation ratio calculated using a trend line that is set using a scheduled amount of the agricultural produce to be collected per day and indicates an ideal change in an amount of the agricultural produce to be collected from when collection of the agricultural produce is started until the collection ends, the deviation ratio indicating a degree of deviation in an amount of the agricultural produce that has been collected from the trend line at a plurality of time points on previous days; and
a regulation result indicating whether the amount of the collected agricultural produce on a corresponding day was successfully or unsuccessfully regulated.

8. The collection amount regulation assist apparatus according to claim 7,
wherein the learning estimation unit
constructs the learning model by calculating, using the deviation ratio included in the learning data, a probability distribution with the deviation ratio as a variable regarding unsuccessful cases where the amount of the collected agricultural produce was unsuccessfully regulated,
applies the deviation ratio at the specific time point to the calculated probability distribution, and obtains, using a value that is obtained thereby, a posterior probability regarding the unsuccessful cases, and
estimates whether or not the agricultural produce will be insufficient based on the obtained posterior probability.

9. The collection amount regulation assist apparatus according to claim 7,
wherein a linear function in a coordinate system having an amount collected and time as two orthogonal axes is set as the trend line, the linear function passing from a first point at which the amount collected is zero and the time is a collection start time, and through a second point at which the amount collected is the scheduled amount to be collected and the time is a collection end time.

10. The collection amount regulation assist apparatus according to claim 7,
wherein, if the learning estimation unit estimates that the agricultural produce will be insufficient, the learning estimation unit notifies an external terminal designated in advance that the agricultural produce will be insufficient.

11. A method for assisting in regulation of an amount of agricultural produce collected at a collection/loading station, comprising:
a step (a) of setting a trend line indicating an ideal change in an amount of the agricultural produce to be collected from when collection of the agricultural produce is started until the collection ends, using a scheduled amount of the agricultural produce to be collected per day; and
a step (b) of obtaining a deviation ratio indicating a degree of deviation in an amount of the agricultural produce that has been collected from the trend line at a specific time point, and estimating, based on the obtained deviation ratio, whether or not the agricultural produce will be insufficient.

12.-16. (canceled)

17. A method for assisting in regulation of an amount of agricultural produce collected at a collection/loading station, comprising:
a step (a) of constructing a learning model of a deviation ratio by using learning data, applying the deviation ratio at a specific time point to the constructed learning model, and estimating whether or not the agricultural produce will be insufficient based on a thus obtained result,
wherein the learning data includes:
the deviation ratio calculated using a trend line that is set using a scheduled amount of the agricultural produce to be collected per day and indicates an ideal change in an amount of the agricultural produce to be collected from when collection of the agricultural produce is started until the collection ends, the deviation ratio indicating a degree of deviation in an amount of the agricultural produce that has been collected from the trend line at a plurality of time points on previous days; and
a regulation result indicating whether the amount of the collected agricultural produce on a corresponding day was successfully or unsuccessfully regulated.

18.-20. (canceled)

21. A non transitory computer-readable recording medium storing a program for assisting, using a computer, in regulation of an amount of agricultural produce collected at a collection/loading station, the program comprising a command for causing the computer to execute:
a step (a) of setting a trend line indicating an ideal change in an amount of the agricultural produce to be collected from when collection of the agricultural produce is started until the collection ends, using a scheduled amount of the agricultural produce to be collected per day; and
a step (b) of obtaining a deviation ratio indicating a degree of deviation in an amount of the agricultural produce that has been collected from the trend line at a specific time point, and estimating, based on the obtained deviation ratio, whether or not the agricultural produce will be insufficient.

22.-26. (canceled)

27. A non transitory computer-readable recording medium storing a program for assisting, using a computer, in regulation of an amount of agricultural produce collected at a collection/loading station, the program comprising a command for causing the computer to execute:
a step (a) of constructing a learning model of a deviation ratio by using learning data, applying the deviation ratio at a specific time point to the constructed learning model, and estimating whether or not the agricultural produce will be insufficient based on a thus obtained result,
wherein the learning data includes:
the deviation ratio calculated using a trend line that is set using a scheduled amount of the agricultural produce to be collected per day and indicates an ideal change in an amount of the agricultural produce to be collected from when collection of the agricultural produce is started until the collection ends, the deviation ratio indicating a degree of deviation in an amount of the agricultural produce that has been collected from the trend line at a plurality of time points on previous days; and
a regulation result indicating whether the amount of the collected agricultural produce on a corresponding day was successfully or unsuccessfully regulated.

28.-30. (canceled)
